(19) United States
(12) Patent Application Publication
(10) Pub. No.: US 2022/0080982 A1
(43) Pub. Date: Mar. 17, 2022

(54) METHOD AND SYSTEM FOR CREATING A ROAD MODEL

(71) Applicant: Conti Temic microelectronic GmbH, Nürnberg (DE)

(72) Inventors: Peter Barth, Wolnzach (DE); Kristian Rackow, Grasbrunn (DE); Sara Gallian, München (DE); Xiaoying Cong, München (DE); Haoyuan Ying, Ottobrunn (DE)

(73) Assignee: Conti Temic microelectronic GmbH, Nürnberg (DE)

(21) Appl. No.: 17/447,817

(22) Filed: Sep. 16, 2021

(30) Foreign Application Priority Data
Sep. 17, 2020 (DE) 10 2020 211 649.0

(51) Int. Cl. B60W 50/00; G01C 21/00

(52) U.S. Cl. CPC B60W 50/00; G01C 21/3822; B60W 2050/0028; B60W 2555/60; B60W 2554/20; B60W 2554/4042; B60W 2554/4043; B60W 2552/05

(57) ABSTRACT

A method for creating a road model for a driver assistance system of an ego vehicle includes recording the surroundings of the ego vehicle with at least one environment detection sensor. The method also includes detecting static and/or dynamic objects and creating a grid map having a plurality of grid cells. Static objects are entered into the grid map as occupied grid cells. The method also includes tracking the static objects and/or the dynamic objects. Information regarding a road profile is deduced based on the detections entered in the grid map and the tracked objects. A road model with the deduced information is created. The road model is provided to at least one driver assistance system.

### TECHNICAL FIELD

The technical field relates to a method and a system for creating a road model for a driver assistance system of an ego vehicle.

### BACKGROUND

Current sensors such as a radar or camera recognize moving and static objects and structures which are used for the creation of an environment model. Depending on the object type, the objects can be recognized and classified with varying quality and accuracy. A major challenge is, e.g., the accurate recognition of intersections, junctions and other turn-offs of the current road profile.

Map material can help here, but the up-to-date nature of the data cannot be assessed. In addition, intersections, junctions, etc. do not necessarily have to be present in the map. This can happen, on the one hand, due to outdated data but also due to incomplete map material and irrelevant minor roads such as, e.g., driveways, small culs-de-sac, dirt roads, etc. For the recognition of intersections, turning possibilities, highway on-ramps and exits, there is currently no technology or sensor available to recognize these reliably. These can be partially recognized by different approaches. However, in the case of the current sensor-based technology, there are a large number of false negative results (that is to say, intersections which are not recognized but which do exist) and false positives (that is to say erroneously recognized intersections). In addition, the current technology (except for map data) cannot recognize any attributes such as the turning direction, number of lanes, etc.

As such, it is desirable to provide a method and a system by which a reliable and accurate road model can be created and can be provided to a driver assistance system.

### BRIEF SUMMARY

Initial considerations were that driving functions such as, e.g., EBA or ACC sometimes require a very reliable and functionally secure recognition of intersections for the typical cases of application (e.g., NCAP scenarios). For example, the emergency braking assist (EBA) has to prevent potential collisions with pedestrians or cyclists through timely braking. If a pedestrian is recognized in the region of an intersection and the driving function predicts or estimates that the ego vehicle would like to turn, the collision must be prevented in case of doubt.

Since this recognition of intersections, junctions and turnoffs is often inaccurate or the input data used is functionally unsafe (e.g., map data), the driving functions (in particular EBA, ACC) will only trigger their function if they are certain about the input data, since it is imperative to avoid false positive actuations.

Since the driving function does not know the future, a prediction must take place both for the ego vehicle and for other road users about what will presumably happen (intention recognition).

A method for creating a road model for a driver assistance system of an ego vehicle having the following steps is therefore proposed according to the invention:
recording the surroundings of the ego vehicle by means of at least one environment detection sensor;
detecting static and/or dynamic objects;
creating a grid map with a plurality of grid cells;
entering the static objects into the grid map as occupied grid cells and tracking the static objects and/or tracking the dynamic objects;
deducing information regarding a road profile based on the detections entered in the grid map and the tracked static and/or dynamic objects;
creating a road model with the deduced information;
providing the road model for at least one driver assistance system.

The environment detection sensor is particularly preferably a radar sensor. It would also be conceivable to use multiple radar sensors. The use of at least one radar sensor is advantageous in that the latter supplies a plurality of static and dynamic detections, wherein the static objects can be accumulated in a grid map. Furthermore, the static and the dynamic objects can be tracked over time. When tracking the dynamic objects, all of the positions detected in the period of tracking can be saved in order to obtain a movement profile or a trajectory traveled by the dynamic object. In light of the invention, static objects are understood to mean, e.g., guardrails, curbs, walls, fences, etc., which indicate clear drivability limits. Dynamic objects are in particular understood to mean recognized road users, preferably other vehicles, which are observed over a longer period of time. The calculation of the grid map can be carried out, for example, directly on the ECU of the radar sensor.

All of the detected static objects can be entered into the grid map as occupied grid cells. The dynamic objects are merely tracked over time.

It would also be conceivable that, prior to providing the road model to the driver assistance system, the road model is stored in a storage device so that it is already available to the assistance system when the route is driven again. A comparison can then be made based on the current data in order to recognize alterations in the road model, if necessary, and to update the saved model. It would also be conceivable to use data from other sensors, such as a camera, lidar and/or ultrasound, and/or map data in order to verify, for example, the detections recognized by the radar sensor and the road model deduced therefrom and to make the road model even more secure.

In a preferred embodiment, semantic properties of the dynamic objects are established by the tracking of the dynamic objects. The dynamic objects can be further determined by means of the semantic properties.

The semantic properties particularly preferably comprise the type of object, alignment of the object, direction of movement and/or speed of movement. The establishment of these properties is advantageous since an improved prediction of the trajectory of the dynamic objects is made possible with these properties and can consequently become a more accurate road model. Thus, for example, the type of object can be established from the radar detections since a car generates different reflections, for example, to a motorcycle or a bicycle. An acceleration potential can be determined, for example, with the type of object since a motorcycle can, as a general rule, accelerate more quickly than a car. Furthermore, it can thus be ascertained whether, e.g., a bicycle is being ridden on a cycle track next to the ego lane. This information about the presence of a cycle track can also be incorporated into the road model and can be provided to the driver assistance system. Such a cycle track can also be described in the grid map with grid cells which are labeled, for example, as “not to be used”, which inform the driver assistance system that this section of road could indeed be used but is not to be used under normal conditions.

The further road profile and the direction of the lanes can be advantageously determined from the direction of movement of the other road users.

In a further preferred embodiment, the information regarding the road profile comprises turning possibilities, intersections and/or turning restrictions.

Turning possibilities, in light of the invention, cannot only be streets branching off, but also entrances to houses or parking lots or dirt roads. A turning restriction is understood to mean that due to the detected static objects along the trajectory of the vehicle there is no possibility for the vehicle to turn off. However, if no objects are detected along the trajectory, it cannot be inferred therefrom that there is a turning possibility, which is why further data have to be established for the recognition of a turning possibility. However, in the case of a recognized turning restriction, it can be concluded that, for example, if a pedestrian is recognized behind the restriction, it is not to be expected that the pedestrian will cross the trajectory of the ego vehicle. Correspondingly, downstream driver assistance systems can, for example, adapt intervention thresholds.

Furthermore, turning possibilities and intersections are particularly preferably established by means of a traffic flow analysis based on the tracked dynamic objects. This procedure is advantageous since it can be established with a very high level of certainty during the tracking of dynamic objects or other vehicles whether a vehicle can turn, or whether an intersection is present, since otherwise no other vehicles would move in the corresponding direction. Furthermore, a statement can also be particularly advantageously made about the number of lanes or the direction of travel of the lanes by means of such a traffic flow analysis.

In a further particularly preferred configuration, a confidence value for the turning possibilities and/or intersections is established based on the traffic flow analysis. The more detections of, and tracking information regarding, road users which are moving in a specific direction are available, the more reliably a statement can be made about a turning possibility or an intersection. Correspondingly, the recognized turning possibility or intersection can be provided with a confidence value. A corresponding confidence value can likewise be established for an established turning restriction, which is then based on the tracked static objects. The calculation of the respective confidence values can also be carried out in the ECU of the radar sensor. Furthermore, the traffic flow analysis is suitable for safely recognizing the direction of the lane.

In a preferred configuration, turning restrictions are established based on the tracked static objects. Continuous roadway boundaries such as, for example, guardrails can be recognized particularly advantageously with this method. Individual missing or erroneous detections can also be compensated for by the tracking.

Furthermore, a system for creating a road model for a driver assistance system of an ego vehicle is proposed according to the invention, wherein the system has at least one environment detection sensor for recording the surroundings and a computing unit, by means of which a grid map can be created and detected static objects can be entered into the grid map and static and/or dynamic objects can be tracked, wherein the computing unit is further configured to create a road model and to provide it to a driver assistance system.

The computing unit can be, for example, the ECU of the environment detection sensor. The environment detection sensor is preferably a radar sensor. The driver assistance system can be an EBA system or an ACC system, for example. A turning assistant and/or a lane keeping assistant would also be conceivable.

### BRIEF DESCRIPTION OF THE DRAWINGS

Further advantageous configurations are the subject-matter of the drawings, wherein:

FIG. 1: shows a schematic representation of a grid map according to an embodiment of the invention;

FIG. 2: shows a schematic representation of a road model according to an embodiment of the invention;

FIG. 3: shows a schematic flowchart of a method according to an embodiment of the invention;

FIG. 4: shows a schematic representation of a system according to an embodiment of the invention.

### DETAILED DESCRIPTION

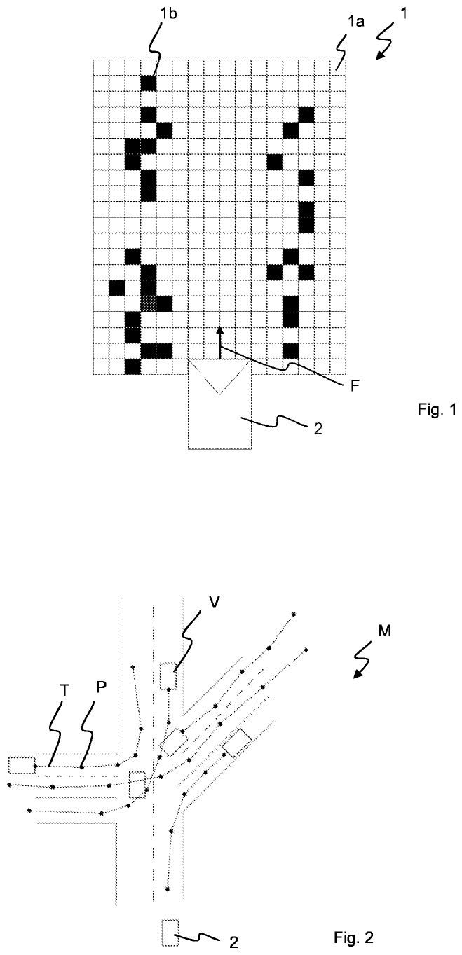

A schematic representation of a grid map 1 according to an embodiment is shown in FIG. 1. The grid map 1 consists of a plurality of grid cells 1a. Detections of the ego vehicle 2 are entered into the grid map 1 as occupied grid cells 1b. This representation concerns static detections in the direction of travel F of the ego vehicle 2 which, in each case, describe a roadway boundary on the left and right sides of the ego vehicle 2.

FIG. 2 shows a schematic representation of a road model M according to an embodiment. In this road model M, several other road users V have been observed over a specific period of time and their movement tracked. For reasons of clarity, the same elements have only been provided with a reference numeral once. In the road model M, the tracked movement T and individual detection points P of the respective road user V are shown. Consequently, it can be established what distance has been covered by the road users V and in which direction they are moving. It can then be deduced from this information what the road profile is, whether there is a turning possibility or an intersection, how many lanes are present and in which direction of travel these lanes point.

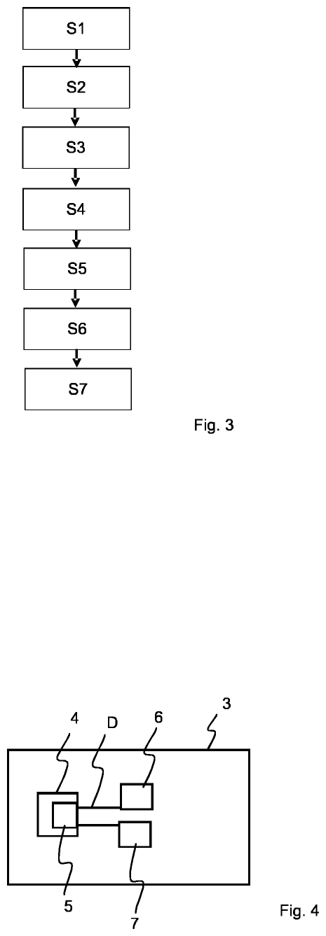

FIG. 3 shows a schematic flowchart of a method according to an embodiment. In a first step S1, the surroundings are recorded by at least one environment detection sensor 4. In step S2, static and/or dynamic objects are detected. In a subsequent step S3, a grid map 1 having a plurality of grid cells 1a is created. In step S4, the detected static objects are entered into the grid map 1 as occupied grid cells 1b and the static and/or dynamic objects are tracked over time. Based on the detections entered in the grid map 1 and the tracked static and/or dynamic objects, information regarding a road profile is deduced in step S5.

In step S6, a road model M is created with the deduced information. Finally, the road model M for at least one driver assistance system 6 is provided in step S7.

In FIG. 4, a schematic representation of a system 3 according to an embodiment of the invention is shown. The system 3 comprises an environment detection sensor 4 having a computing unit 5. In this configuration, the computing unit 5 is the ECU of the environment detection sensor 4. The environment detection sensor 4 is preferably a radar sensor. Furthermore, the computing unit 5 is connected by means of a data connection D to a driver assistance system 6 in order to provide the road model M created in the computing unit 5 to the driver assistance system 6. In this embodiment, a storage device 7 is furthermore provided, which is likewise connected to the computing unit 5 by means of a data connection D. As a result, the created road model M can be stored in the storage device 7.

### LIST OF REFERENCE NUMERALS

1 Grid map
1a Grid cells
1b Occupied grid cells
2 Ego vehicle
3 System
4 Environment detection sensor
5 Computing unit
6 Driver assistance system
7 Storage device
D Data connection
F Direction of travel of ego vehicle
M Road model
P Detection points
T Tracked movement
V Road users
S1-S7 Method steps

1. A method for creating a road model for a driver assistance system of an ego vehicle, comprising:
recording the surroundings of the ego vehicle utilizing at least one environment detection sensor (4);
detecting static and/or dynamic objects;
creating a grid map having a plurality of grid cells;
entering the static objects into the grid map as occupied grid cells and tracking the static objects and/or tracking the dynamic objects;
deducing information regarding a road profile based on the detections entered in the grid map and the tracked static and/or dynamic objects;
creating a road model with the deduced information;
providing the road model for at least one driver assistance system.

2. The method according to claim 1, wherein semantic properties of the dynamic objects are established by the tracking of the dynamic objects.

3. The method according to claim 2, wherein the semantic properties comprise direction of movement and speed of movement.

4. The method according to claim 1, wherein the information regarding the road profile comprises turning possibilities, intersections, and/or turning restrictions.

5. The method according to claim 1, wherein turning possibilities and/or intersections are established utilizing a traffic flow analysis based on the tracked dynamic objects.

6. The method according to claim 5, wherein a confidence value for the turning possibilities and/or intersections is established based on the traffic flow analysis.

7. The method according to claim 4, wherein the turning restrictions are established based on the tracked static objects.

8. A system for creating a road model for a driver assistance system of an ego vehicle, wherein the system has comprises:
at least one environment detection sensor for recording the surroundings and for detecting static and/or dynamic objects; and
a computing unit, by which a grid map can be created and detected static objects can be entered into the grid map and static and/or dynamic objects can be tracked, wherein the computing unit is further configured to create a
road model and to provide it to a driver assistance system.
